(19) United States
(12) Patent Application Publication
(10) Pub. No.: US 2019/0237773 A1
(43) Pub. Date: Aug. 1, 2019

(54) SEPARATOR FOR FUEL CELL

(71) Applicant: Toyota Jidosha Kabushiki Kaisha, Toyota-shi Aichi-ken (JP)

(72) Inventors: Yuhei Asano, Miyoshi-shi Aichi (JP); Hiroshi Yanagimoto, Miyoshi-shi Aichi (JP); Katsumi Ito, Seto-shi Aichi (JP)

(21) Appl. No.: 16/261,927

(22) Filed: Jan. 30, 2019

(30) Foreign Application Priority Data
Jan. 31, 2018 (JP) 2018-015084

(51) Int. Cl. H01M 8/0228; H01M 8/0226; H01M 8/0213; H01M 8/0206

(52) U.S. Cl. CPC H01M 8/0228; H01M 8/0206; H01M 8/0213; H01M 8/0226

(57) ABSTRACT

Provided is a separator for fuel cell that can reduce the initial contact resistance and the contact resistance under the corrosive environment. A separator for fuel cell includes a metal substrate and a surface layer on the surface of the metal substrate. The surface layer includes CNT and a Si-based binder. The surface layer has the surface coverage of the CNT that is 90% or more and the ratio of the Si-based binder that is 40% or more.

### CROSS REFERENCE TO RELATED APPLICATIONS

The present application claims priority from Japanese patent application JP 2018-015084 filed on Jan. 31, 2018, the content of which is hereby incorporated by reference into this application.

### BACKGROUND

### Technical Field

The present disclosure relates to a separator for fuel cell.

### Background Art

A fuel cell includes a stack of a plurality of individual fuel cells, and generates electrical power through an electrochemical reaction between oxidation gas and fuel gas supplied. Each of the individual fuel cells includes a membrane-electrode-assembly (hereinafter called a MEA) having an electrolyte membrane and a pair of electrodes sandwiching the electrolyte membrane, and a pair of separators for fuel cell (hereinafter called separators) sandwiching the MEA. Alternatively each individual fuel cell includes a membrane-electrode-gas diffusion layer-assembly (hereinafter called a MEGA) including a gas diffusion layer on either side of the MEA for better power collection and a pair of separators sandwiching the MEGA.

As described in JP 2011-508376A, for example, a separator has a metal substrate and a surface layer on the surface of the metal substrate, and the surface layer includes carbon particles and binder resin. To increase the power-generation efficiency of the fuel cell, it is important for such a separator to reduce contact resistance between the separator and the neighboring electrode (in the case of a MEA) or between the separator and the neighboring gas diffusion layer (in the case of a MEGA). More specifically small contact resistance is required for both of the initial contact resistance between the separator and the neighboring electrode or gas diffusion layer and the contact resistance under the corrosive environment.

### SUMMARY

The separator described in JP 2011-508376A has the following problems. Lower surface coverage with the carbon particles at the surface layer means a smaller contact part between the carbon particles and the neighboring electrode or gas diffusion layer, which increases the initial contact resistance. Since this separator includes binder resin, corrosive liquid such as water easily penetrates. Advanced penetration of the corrosive liquid causes the growth of an oxide film at the interface between the surface layer and the metal substrate, which may degrade the contact resistance.

To solve such technical problems, the present disclosure provides a separator for fuel cell that can reduce the initial contact resistance and the contact resistance under the corrosive environment.

A separator for fuel cell according to the present disclosure including a metal substrate and a surface layer on a surface of the metal substrate. The surface layer includes a carbon-based conductive material and a Si-based binder, and the surface layer has the surface coverage of the carbon-based conductive material that is 90% or more and the ratio of the Si-based binder that is 40% or more.

The surface layer of the separator for fuel cell according to the present disclosure has the surface coverage of the carbon-based conductive material that is 90% or more. This can realize a sufficient electron-conductive path, and can reduce the initial contact resistance. In addition, the ratio of the Si-based binder in the surface layer is 40% or more, and this can prevent the penetration of corrosive liquid, and so can reduce the contact resistance under the corrosive environment. As a result, the initial contact resistance and the contact resistance under the corrosive environment can reduce.

In some embodiments of the separator for fuel cell according to the present disclosure, the carbon-based conductive material includes carbon nanotube. With this configuration, due to excellent dispersibility of the carbon nanotube, the carbon nanotube can be dispersed uniformly over the entire surface layer. This can stabilize the contact resistance.

The present disclosure can reduce the initial contact resistance and the contact resistance under the corrosive environment.

### BRIEF DESCRIPTION OF THE DRAWINGS

FIG. 1 is a schematic cross-sectional view of the major part of a fuel cell including a separator for fuel cell according to one embodiment;

FIG. 2 is a schematic cross-sectional view of a separator for fuel cell according to one embodiment;

FIG. 3 shows the relationship between the surface coverage of CNT and the initial contact resistance of Examples and Comparative Examples; and

FIG. 4 shows the relationship between the ratio of the Si-based binder and the contact resistance of Examples and Comparative Examples.

### DETAILED DESCRIPTION

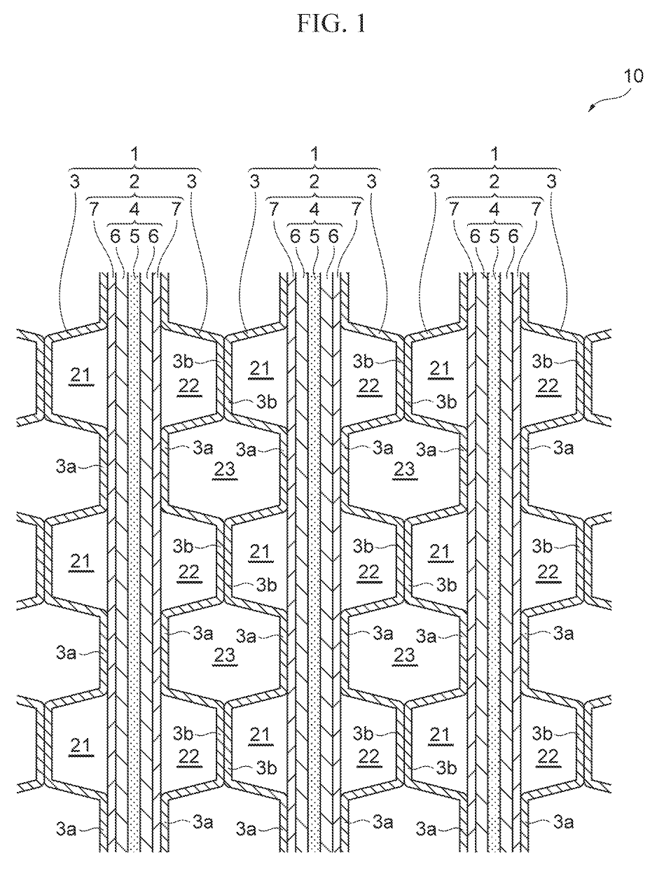

The following describes one embodiment of a separator for fuel cell according to the present disclosure, with reference to the drawings. Firstly the following briefly describes the structure of a fuel cell including a separator for fuel cell with reference to FIG. 1. The following describes the structure by way of an example of the fuel cell including a MEGA.

FIG. 1 is a schematic cross-sectional view of the major part of a fuel cell including a separator for fuel cell according to one embodiment. As shown in FIG. 1, a fuel cell 10 includes a stack of a plurality of individual fuel cells 1 as the base units. Each fuel cell 1 is a solid polymer fuel cell that generates electrical power through an electrochemical reaction between oxidation gas (e.g., air) and fuel gas (e.g., hydrogen gas). The fuel cell 1 includes a MEGA (membrane-electrode-gas diffusion layer-assembly) 2 and a pair of separators 3, 3 sandwiching the MEGA 2.

The MEGA 2 includes a MEA (membrane-electrode-assembly) 4 integrated with the gas diffusion layers 7 and 7 disposed on both sides of the MEA 4. The MEA 4 includes an electrolyte membrane 5 and a pair of electrodes 6 and 6 that are bonded with the electrolyte membrane 5 so as to sandwich the electrolyte membrane therebetween. The electrolyte membrane 5 includes a proton-conducting ion-exchange membrane made of solid polymer. The electrodes 6 may be made of a porous carbon material loaded with a catalyst, such as platinum. The electrode 6 disposed on one side of the electrolyte membrane 5 serves as an anode electrode and the electrode 6 on the other side serves as a cathode electrode. The gas diffusion layer 7 includes a conductive member having gas permeability, including a carbon porous body, such as carbon paper or carbon cloth, or a metal porous body, such as metal mesh or foam metal.

In the present embodiment, the MEGA 2 serves as a power-generation part of the fuel cell 10, and the separators 3 are disposed in contact with the gas diffusion layers 7 of the MEGA 2. In the case of a fuel cell including a MEA 4 without the gas diffusion layers 7, the MEA 4 serves as a power-generation part. In this case, the separators 3 are disposed in contact with the electrodes 6 of the MEA 4.

Each separator 3 is undulating that is formed by repeating depressions 3a and projections 3b alternately. Each depression 3a has a flat bottom that is in a plane contact with the corresponding gas diffusion layer 7 of the MEGA 2. Each projection 3b also has a flat top that is in a plane contact with the top of the corresponding projection 3b of the neighboring separator 3.

As shown in FIG. 1, one of the gas diffusion layer 7 of the pair of the gas diffusion layers 7 and 7 defines a fuel-gas flow channel 21 together with the projections 3b of the neighboring separator 3 to flow the fuel gas. The other gas diffusion layer 7 defines an oxidation-gas flow channel 22 together with the projections 3b of the neighboring separator 3 to flow the oxidation gas.

As shown in FIG. 1, the fuel cells 1 are stacked so that the anode electrode 6 of a fuel cell 1 faces the cathode electrode 6 of the neighboring fuel cell 1. These stacked neighboring separators 3 define a space 23 between their depressions 3a. This space 23 serves as a coolant flow channel to flow coolant.

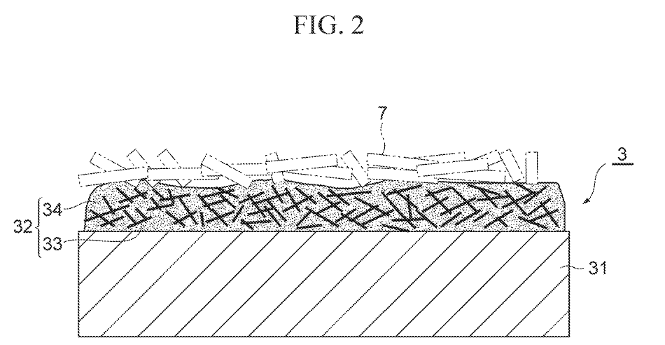

FIG. 2 is a schematic cross-sectional view of a separator for fuel cell according to one embodiment. As shown in FIG. 2, the separator 3 includes a plate-like metal substrate 31 and a surface layer 32 on the surface of the metal substrate 31. The metal substrate 31 is made of a material having excellent conductivity and a property that does not transmit gas, such as titanium, titanium alloys, stainless steel and aluminum alloys.

The surface layer 32 includes a carbon-based conductive material and a Si-based binder 34. For the carbon-based conductive material, a material that can be dispersed into solution and does not elute in the usage environment of the fuel cell. The examples of the carbon-based conductive material include carbon particles, such as carbon nanotube, carbon black, artificial graphite, natural graphite, and expanded graphite. In the present embodiment, carbon nanotube (hereinafter called CNT) 33 is used for the carbon-based conductive material. The types of the Si-based binder 34 are not limited especially, and the Si-based binder 34 may be an inorganic Si-based binder.

In some embodiments, the length of the CNT 33 is from 1 μm to a few tens of μm. In the present embodiment, the length of the CNT 33 is set at 1 μm to 90 μm due to the following reasons. That is, if the length of the CNT 33 is less than 1 μm, the conductive path reduces. Then the contact resistance increases, and the conductivity deteriorates. If the length of the CNT 33 exceeds 90 μm, the CNT 33 tends to gather, i.e., the CNT 33 tends to have clumps. Such CNT 33 therefore cannot be dispersed uniformly, and so the dispersibility of the CNT 33 deteriorates.

In the surface layer 32, the surface coverage of the CNT 33 is 90% or more, and the ratio of the Si-based binder 34 is 40% or more. The surface coverage indicates the ratio of the area of the carbon nanotube to the surface area, and a method for calculating the surface coverage is described later. The ratio of the Si-based binder is a ratio of the Si-based binder to the overall mass of the surface layer 32.

The surface layer 32 having such a structure is formed by applying a Si-based binder solution including the dispersed CNT 33 to the surface of the metal substrate 31, followed by heating and surface treatment. In some embodiments, the thickness of the surface layer 32 is in the range of 3 m to 10 μm due to the following reasons. If the thickness of the surface layer 32 is less than 3 μm, the corrosion resistance deteriorates. If the thickness of the surface layer 32 exceeds 10 μm, the cost increases.

The surface layer 32 of the separator 3 in the present embodiment has the surface coverage of the CNT 33 that is 90% or more. This can realize a sufficient electron-conductive path, and can reduce the initial contact resistance. In addition, the ratio of the Si-based binder 34 is 40% or more, and this can prevent the penetration of corrosive liquid, and so can reduce the contact resistance under the corrosive environment. As a result, the initial contact resistance and the contact resistance under the corrosive environment can reduce. With this configuration, both of the initial contact resistance between the separator 3 and the neighboring gas diffusion layer 7 and the contact resistance under the corrosive environment can be 10 mΩcm² or less.

The CNT 33 used for the carbon-based conductive material has excellent dispersibility, and so the CNT 33 can be dispersed uniformly over the entire surface layer. This can stabilize the contact resistance.

The present embodiment describes the example of the surface layer 32 on one of the two principal surfaces of the plate-like metal substrate 31 (see FIG. 2). The surface layer 32 may be formed on both of the principal surfaces of the metal substrate 31 as needed.

The following describes the present disclosure by way of examples, and the present disclosure is not limited to the examples.

### Examples 1 to 3

In Examples 1 to 3, samples of the separators having various conditions shown in Table 1 were prepared in accordance with the following manufacturing method, and the initial contact resistance with the gas diffusion layer and the contact resistance after anticorrosion test were evaluated.

TABLE 1

| | | | | | | | Contact |
|---|---|---|---|---|---|---|---|
| | | | | | | | resistance |
| | Thickness | Ratio of | Ratio of | Ratio of | CNT | Initial | after |
| | of surface | CNT in | dispersant in | Si-based binder | surface | contact | anticorrosion |
| | layer | surface layer | surface layer | in surface layer | coverage | resistance | test |
| | [μm] | [%] | [%] | [%] | [%] | [mΩ cm²] | [mΩcm²] |
| Comp. Ex. 1 | 10 | 20 | 5 | 75 | 41 | 60.1 | 60.2 |
| Comp. Ex. 2 | 10 | 20 | 10 | 70 | 62 | 35.2 | 34.5 |
| Comp. Ex. 3 | 10 | 20 | 15 | 65 | 85 | 15.8 | 15.2 |
| Ex. 1 | 10 | 20 | 20 | 60 | 90 | 7.1 | 6.5 |
| Ex. 2 | 10 | 20 | 30 | 50 | 96 | 5.3 | 5.2 |
| Ex. 3 | 10 | 20 | 40 | 40 | 100 | 4.9 | 5.1 |
| Comp. Ex. 4 | 10 | 20 | 50 | 30 | 100 | 5.5 | 16.5 |
| Comp. Ex. 5 | 10 | 20 | 60 | 20 | 100 | 6.0 | 19.2 |
| Comp. Ex. 6 | 10 | 20 | 70 | 10 | 100 | 4.5 | 35.2 |

Specifically CNT and a dispersant were added to a Si-based solution as the base of the binder, followed by agitation for mixture. The raw materials of the samples of Examples 1 to 3 shown in Table 1 were prepared by adjusting the ratio of the dispersant. Subsequently, the prepared raw materials of the samples were dropped on the surface of the metal substrate, and were applied with a bar coater. Next, the prepared samples were heated at the temperature of 300° C. for 30 minutes to cure the applied film, whereby the samples of the separators of Examples 1 to 3 were prepared. The examples of the dispersant include anion surfactant, cation surfactant, amphoteric surfactant and non-ionic surfactant.

Next the surface layer of each sample and the gas diffusion layer (produced by Toray Industries, Inc. TGP-H-060) were overlapped, and voltage was measured between the separator and the gas diffusion layer under the load of 1 MPa while applying the current of 1 A. Then the measured value was converted into resistance, and the resultant was multiplied by the evaluation area to obtain the initial contact resistance for evaluation.

The test to evaluate corrosion resistance was performed assuming the actual environment to use the fuel cell. Specifically while the prepared samples were immersed in strong acid corrosive liquid, potential of the constant voltage of 0.9 V was applied between the separator and the gas diffusion layer. After a certain period of time, the contact resistance was measured as the value to be evaluated after the anticorrosion test. For the strong acid corrosive liquid, strong-acid solution containing fluorine and chlorine and of pH3 was used.

The surface coverage of CNT was measured as follows. Firstly the surface of a SEM image was observed with a laser microscope, and the observed image was binarized about the presence or not of the CNT. Based on the binarized image, the ratio of covering with CNT was calculated as the surface coverage.

### Comparative Examples 1 to 6

For comparison, samples of the separators (Comparative Examples 1 to 6) having various conditions shown in Table 1 were prepared by the same method as in the above Examples, and the initial contact resistance with the gas diffusion layer and the contact resistance after anticorrosion test were evaluated by the same method. Comparative Examples 1 to 6 were different from Examples in the surface coverage of CNT and the ratio of Si-based binder.

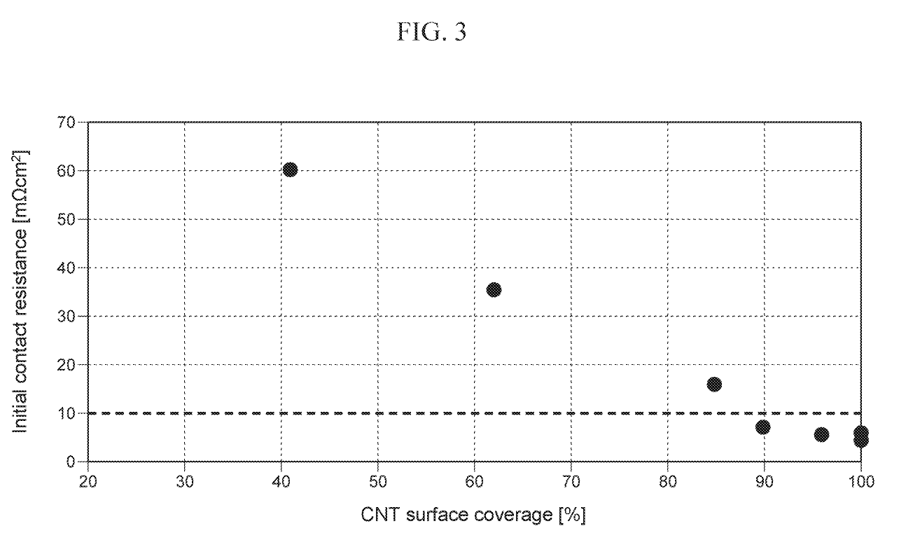

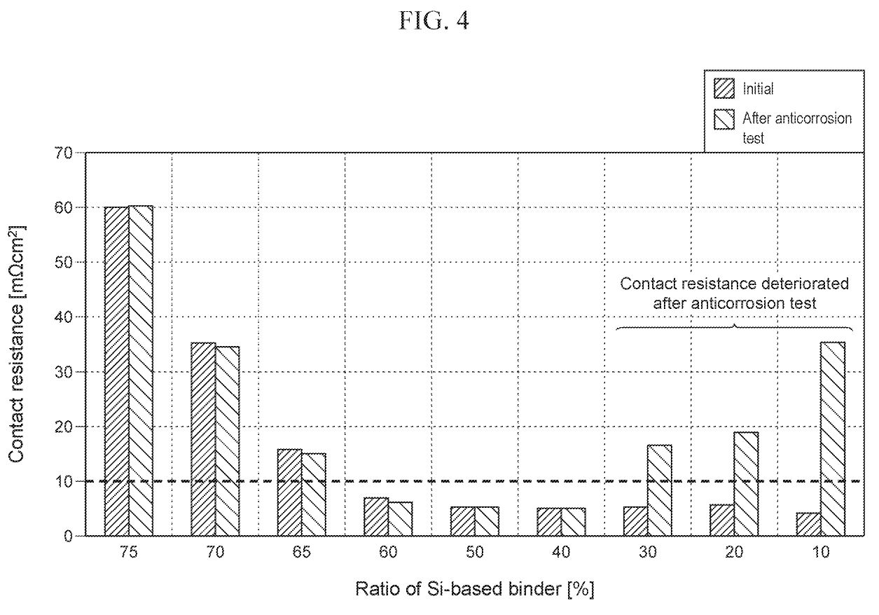

Table 1 and FIGS. 3 and 4 show the result of evaluation. FIG. 3 shows the relationship between the surface coverage of CNT and the initial contact resistance of Examples and Comparative Examples. FIG. 4 shows the relationship between the ratio of the Si-based binder and the contact resistance of Examples and Comparative Examples.

As shown in Table 1 and FIG. 3, the initial contact resistance decreased with an increase in the surface coverage of CNT. When the surface coverage of CNT was 90% or more, the initial contact resistance between the separator and the gas diffusion layer became 10 mΩcm² or less (see FIG. 3). Presumably when the surface coverage of CNT increases, a contact part between the separator and the gas diffusion layer increases, so that the contact resistance decreases.

As shown in FIG. 4, Comparative Examples 4 to 6 had the surface coverage of CNT of 90% or more, and their initial contact resistance was 10 mΩcm² or less. However, the contact resistance after the anticorrosion test exceeded 10 mΩcm². Presumably the ratio of the Si-based binder of these Comparative Examples was less than 40%, and so the corrosive liquid easily penetrated. This caused the growth of an oxide film at the interface between the surface layer and the metal substrate, which degraded the contact resistance. As shown in FIG. 4, when the ratio of the Si-based binder in the surface layer was 40% or more, no change was observed between the initial contact resistance and the contact resistance after the anticorrosion test. Presumably a higher ratio of the Si-based binder suppressed the penetration of corrosive liquid, and so suppressed the growth of an oxide film at the interface between the surface layer and the metal substrate.

The above results show that in order to keep the contact resistance between the separator and the gas diffusion layer at 10 mΩcm² or less under the environment to use the fuel cell, the surface coverage of CNT in the surface layer has to be 90% or more and the ratio of the Si-based binder in the surface layer has to be 40% or more.

That is a detailed description of the embodiments of the present disclosure. The present disclosure is not limited to the above-stated embodiments, and the design may be modified variously without departing from the spirits of the present disclosure defined in the attached claims. For instance, the above embodiment describes carbon nanotube as an example of the carbon-based conductive material, and the present disclosure is applicable to another carbon-based conductive material, such as carbon black or carbon particles.

What is claimed is:

1. A separator for fuel cell, including a metal substrate and a surface layer on a surface of the metal substrate,
the surface layer including a carbon-based conductive material and a Si-based binder, and
the surface layer having a surface coverage of the carbon-based conductive material that is 90% or more and a ratio of the Si-based binder that is 40% or more.

2. The separator for fuel cell according to claim 1, wherein the carbon-based conductive material includes carbon nanotube.
